(19) United States
(12) Patent Application Publication
(10) Pub. No.: US 2015/0227259 A1
(43) Pub. Date: Aug. 13, 2015

(54) TOUCH PANEL CONTROLLER, TOUCH PANEL SYSTEM AND ELECTRONIC EQUIPMENT

(71) Applicant: SHARP KABUSHIKI KAISHA, Osaka-shi, Osaka (JP)

(72) Inventor: Mutsumi Hamaguchi, Osaka-shi (JP)

(73) Assignee: SHARP KABUSHIKI KAISHA, Osaka-shi, Osaka (JP)

(21) Appl. No.: 14/409,362

(22) PCT Filed: May 21, 2013
(86) PCT No.: PCT/JP2013/003236

§ 371 Date: Dec. 18, 2014

(30) Foreign Application Priority Data
Jun. 29, 2012 (JP) 2012-147621

(51) Int. Cl. G06F 3/041; G06F 3/044

(52) U.S. Cl. CPC G06F 3/0418; G06F 3/044; G06F 3/0412

(57) ABSTRACT

An effect of an error factor due to a leakage current via an off resistance when a switch is disposed on the input side of an amplifier is reduced to enable correct detection of a change in capacitance of electrostatic capacitance more accurately.

In a touch panel controller 20 for detecting a touched position on a screen by detecting a capacitance value after amplifying the capacitance value of electrostatic capacitance C between the drive lines and sense lines with an amplifier 3, the. touch panel controller 20 has at least two switching means SWA and SWB connected in series and a predetermined voltage applying section Vcom for outputting a predetermined voltage to a node between the two switching means SWA and SWB through a switching means SWC when the two switching means SWA and SWB are in an off state between an input end of the amplifier 3 and the sense line SL.

### TECHNICAL FIELD

The present invention relates to a touch panel controller for detecting a touched position on a screen by driving a drive line of a touch sensor panel and estimating or detecting a capacitance value of electrostatic capacitance between sense lines and drive lines, a touch panel system using the touch sensor panel and the touch panel controller, and an electronic equipment using the touch panel system.

### BACKGROUND ART

Conventional position inputting devices that detect a position where there is a change in electrostatic capacitance values distributed in a matrix pattern include touch sensor panels installed on a display screen of a display device. As a touch sensor panel, for example, a conventional capacitance detecting device for detecting the distribution of electrostatic capacitance values of an electrostatic capacitance matrix formed between M drive lines and L sense lines that are orthogonal thereto is proposed in Patent Literature 1.

In a touch sensor panel, as this conventional capacitance detecting device, since the electrostatic capacitance value at a touched position changes when a touch panel surface is touched by a finger or a pen, the touch sensor panel detects a position where there is a change in capacitance value to detect such a position as an input position touched by the finger or pen.

FIG. 9 is a schematic diagram showing an example configuration of an essential part of the conventional touch panel system disclosed in Patent Literature 1. FIG. 10 is a diagram for explaining an example of a method of driving the touch panel system of FIG. 9. A plurality of drive lines are driven in parallel (simultaneously) to detect capacitance in Patent Literature 1. However, a simple example is shown herein to explain the basic principles of capacitance detection.

In FIG. 9, a conventional touch panel system 100 comprises a touch sensor panel 110, a touch panel controller 120 for detecting a position where there is a change in electrostatic capacitance of the touch sensor panel 110, and a drive section 130 for driving drive lines DL1 to DL4 of the touch sensor panel 110.

The touch sensor panel 110 has the plurality of drive lines DL1 to DL4 that are arranged in the longitudinal direction, a plurality of sense lines SL1 to SL4 that are arranged in a transverse direction and three-dimensionally intersect therewith, and electrostatic capacitance C11 to C44 disposed at positions where the plurality of drive lines DL1 to DL4 intersect with the plurality of sense lines SL1 to SL4. Herein, an explanation is provided while simplifying to a case in which there are 4×4 of the plurality of drive lines DL1 to DL4 and the plurality of sense lines SL1 to SL4.

The drive section 130 is provided in the touch panel system 100. The drive section 130 drives the drive lines DL1 to DL4 based on the series of symbols in 4 columns and 4 rows shown in FIG. 10 (Formula 3). If an element of the symbol matrix is “1”, the drive section 130 applies a voltage Vdrive. If an element is “0”, zero volts are applied. In summary, the drive section 130 sequentially drives the drive lines DL1 to DL4.

The touch panel system 100 has four amplifiers 140 disposed at positions corresponding to each of the sense lines SL1 to SL4. The amplifiers 140 receive and amplify linear sums of electrostatic capacitance Y1, Y2, Y3, and Y4 along sense lines through drive lines driven by the drive section 130.

For example, in the first drive among four drives by the series of symbols of four columns and four rows described above, the drive section 130 applies voltage Vdrive to drive line DL1 and applies zero volts to the rest of the drive lines DL2 to DL4. Then, for example, the measurement value Y1 from the sense line SL3 corresponding to electrostatic capacitance C31 shown in (Formula 1) of FIG. 10 is output from the amplifier 140.

In the second drive, voltage Vdrive is applied to the drive line DL2 and zero volts are applied to the rest of the drive lines DL1, DL3, and DL4. Then, measurement value Y2 from the sense line SL3 corresponding to electrostatic capacitance C32 shown in (Formula 2) of FIG. 10 is output from the amplifier 140

Next in the third drive, voltage Vdrive is applied to the drive line DL3 and zero volts are applied to the rest of the drive lines. Thereafter in the fourth drive, voltage Vdrive is applied to the drive line DL4 and zero volts are applied to the rest of the drive lines.

In view of the above, as shown in (Formula 3) and (Formula 4) of FIG. 10, the measurement values Y1, Y2, Y3, and Y4 themselves are associated with electrostatic capacitance values C1, C2, C3, and C4, respectively. (Formula 3) to (Formula 4) of FIG. 10 are described while omitting the coefficient (−Vdrive/Cint) for the measurement values Y1 to Y4 for simplifying the description.

The above description is an example of a basic configuration of the conventional touch panel system having the touch sensor panel 110, the touch panel controller 120 and the drive section 130.

Next, a touch panel system is proposed in Patent Literature 2 as a capacitance detecting device with another configuration.

FIG. 11 is a structural diagram showing an example configuration of the conventional touch panel controller disclosed in Patent Literature 2.

As shown in FIG. 11, there is a differential amplifier 201 for detecting capacitance at a position on a touch sensor panel in a conventional touch panel controller 200, on which switches SW1, SW2, SW3, and SW4 or selection circuits that can switch the connection state of an input section of the differential amplifier 201 are disposed. Switching between a differential input mode and a single input mode is realized by the state of the switches SW1, SW2, SW3, and SW4.

Further, the touch panel controller is configured such that capacitance of an input line selected by a selection circuit or a difference in capacitance is detected to estimate the location where capacitance has changed by a touch.

### CITATION LIST

### Patent Literature

### Patent Literature 1: Japanese Patent No. 4387773

### Patent Literature 2: Japanese Laid-Open Publication No. 2011-113186

### SUMMARY OF INVENTION

### Technical Problem

However, the switch configuration on the input side of the differential amplifier 201 of FIG. 11 in the conventional touch panel controller 200 disclosed in Patent Literature 2 would cause an error factor to the differential amplifier 201 due to a leakage current via an off resistance in a switch in an off state.

For example, even if SW4 is in an off state, an error due to a leakage current is introduced in only one input of the differential amplifier 201 when Vref/2 generated by a reference voltage source 202 is different from the voltage at an operation point of the differential amplifier 201. Thus, there was an issue of introducing an error into an output value from the differential amplifier 201.

Further, as described in paragraph 0025 in the specification of Patent Literature 2, it is generally desirable to use a CMOS analog switch for a switch section. However, it has been pointed out that when a CMOS switch with a switch configuration combining NMOS and PMOS is used, due to process variations, the off resistance would be small when a threshold value of MOS is lowered or when operating at a high temperature . However, an error would be larger when a CMOS switch with a switch configuration combining NMOS and PMOS is used.

The present invention solves the above-described conventional issues. The objective of the present invention is to provide a touch panel controller that can reduce an effect of an error factor due to a leakage current via an off resistance when a switch is disposed on the input side of an amplifier to correctly detect a change in capacitance of electrostatic capacitance more accurately, an excellent touch panel system using the same, and an excellent electronic equipment using the same.

### Solution to Problem

A touch panel controller according to the present invention for detecting a touched position on a screen by estimating or detecting a capacitance value after driving a plurality of drive lines of a touch sensor panel and amplifying the capacitance value of electrostatic capacitance between sense lines and the drive lines with an amplifier is provided, comprising, between an input end of the amplifier and sense line, at least two switching means connected in series, and a predetermined voltage applying means for applying a predetermined voltage to a node between the two switching means when the two switching means are in an off state, thereby achieving the objective described above.

Preferably, in the touch panel controller according to the present invention, the predetermined voltage applying means comprises a switching means whose one end is connected to the node, and a predetermined voltage outputting section connected to the other end of the switching means.

Still preferably, in the touch panel controller according to the present invention, the predetermined voltage is a voltage that is the same voltage as a voltage at an operation point of the amplifier or Vdd/2.

Still preferably, in the touch panel controller according to the present invention, the at least two switching means connected in series are CMOS switching means or MEMS switching means.

Still preferably, in the touch panel controller according to the present invention, the touch panel controller has a drive section for sequentially driving the plurality of drive lines at least one at a time to allow a first linear sum output to be output from a plurality of first electrostatic capacitance formed between the plurality of drive lines and each one of the sense lines from the each one of the sense lines, and the amplifier amplifies the first linear sum output in a single input.

Still preferably, in the touch panel controller according to the present invention, the touch panel controller has a drive section for sequentially driving the plurality of drive lines at least one at a time to allow a first linear sum output to be output from a plurality of first electrostatic capacitance formed between the plurality of drive lines and one sense line of the plurality of sense lines from the one sense line and to allow a second linear sum output to be output from a plurality of second electrostatic capacitance formed between the plurality of drive lines and another sense line adjacent to the one sense line from the another sense line, and the amplifier is a differential amplifier that differentially amplifies a difference between the first linear sum output and the second linear sum output.

Still preferably, in the touch panel controller according to the present invention, a plurality of switching means for switching the drive lines and the sense lines with each other are provided between the amplifier and the drive lines and the corresponding sense lines, and each of the plurality of switching means comprises the at least two switching means connected in series and a predetermined voltage applying means for applying a predetermined voltage to anode between the two switching means when the two switching means are in an off state.

Still preferably, in the touch panel controller according to the present invention, each of the capacitance values of electrostatic capacitance in the plurality of sense lines is amplified in a time division by using one amplifier.

Still preferably, in the touch panel controller according to the present invention, the touch panel control comprises the at least two switching means connected in series and the predetermined voltage applying means for applying a predetermined voltage to a node between the two switching means when the two switching means are in an off state at each position between one input end of the one amplifier and the plurality of sense lines.

Still preferably, in the touch panel controller according to the present invention, the touch panel controller comprises: the at least two switching means connected in series and the predetermined voltage applying means for applying a predetermined voltage to a node between the two switching means when the two switching means are in an off state at each position between one of the input ends of the one amplifier and the plurality of sense lines, and the at least two switching means connected in series and the predetermined voltage applying means for applying a predetermined voltage to a node between the two switching means when the two switching means are in an off state at each position between the other input end of the one amplifier and the plurality of sense lines.

Still preferably, in the touch panel controller according to the present invention, a configuration of connecting to each of both differential input ends of the differential amplifier is a symmetrical circuit configuration.

A touch panel system according to the present invention comprising the touch panel controller according to the present invention and the touch sensor panel used by the touch panel controller is provided, thereby achieving the objective described above.

An electronic equipment according to present invention using the touch panel system according to the present invention on a display screen as a position inputting device is provided, thereby achieving the objective described above.

With the configuration described above, the functions of the present invention will be described hereinafter.

In the present invention, in a touch panel controller for detecting a touched position on a screen by estimating or detecting a capacitance value after driving a plurality of drive lines of a touch sensor panel and amplifying the capacitance value of electrostatic capacitance between sense lines and the drive lines with an amplifier, the touch panel controller has at least two switching means connected in series and a predetermined voltage applying means for applying a predetermined voltage to a node between the two switching means when the two switching means are in an off state between an input end of the amplifier and a sense line.

Thereby, an effect of an error factor due to a leakage current via an off resistance when a switch is disposed on the input side of an amplifier is reduced to enable correctly detecting a change in capacitance of electrostatic capacitance more accurately.

### Advantageous Effects of Invention

According to the present invention as described above, an effect of an error factor due to a leakage current via an off resistance when a switch is disposed on the input side of an amplifier can be reduced to enable correctly detecting a change in capacitance of electrostatic capacitance more accurately.

### BRIEF DESCRIPTION OF THE DRAWINGS

FIG. 1 is a schematic diagram showing an example configuration of an essential part of a touch panel system in Embodiment 1 of the present invention.

FIG. 2 is a circuit diagram showing a detailed configuration of each of the switches SW1 to SW4 used in the touch panel system of FIG. 1.

FIG. 3 is a schematic diagram for explaining a case of using one amplifier for a plurality of sense lines SL for sequentially amplifying in a time division in the touch panel system of FIG. 1.

FIG. 4 is a schematic diagram showing an example configuration of an essential part of a touch panel system in Embodiment 2 of the present invention.

FIG. 5 is a schematic diagram for explaining a case of sequentially amplifying in a time division using a two-input differential amplifier for a plurality of sense lines SL in the touch panel system of FIG. 4.

FIG. 6 is a diagram showing switching means used in the present invention, where FIG. 6(a) is a MOS transistor switching means, FIG. 6(b) is a CMOS switching means, and FIG. 6(c) is an MEMS switching means.

FIG. 7 is a schematic diagram showing a case of connecting the touch panel system 1Aa of FIG. 5 as chip A and chip B.

FIG. 8 is a block diagram showing an example of a schematic configuration of an electronic equipment such as a mobile phone device using the touch panel system of Embodiment 1 or 2 of the present invention as Embodiment 3 of the present invention.

FIG. 9 is a schematic diagram showing an example configuration of an essential part of the conventional touch panel system disclosed in Patent Literature 1.

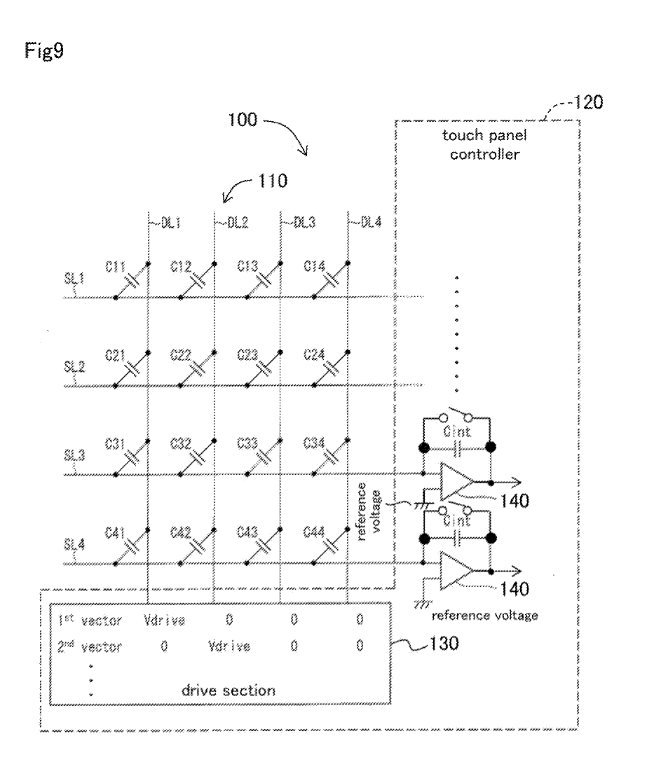

FIG. 10 is a diagram for explaining an example of a method of driving the touch panel system of FIG. 6.

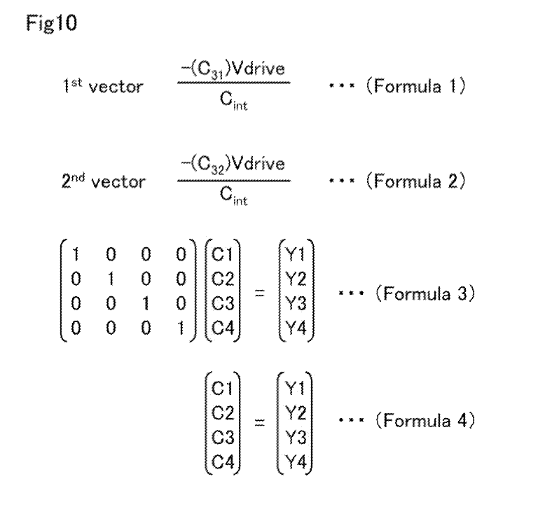

FIG. 11 is a structural diagram showing an example configuration of the conventional touch panel controller disclosed in Patent Literature 2.

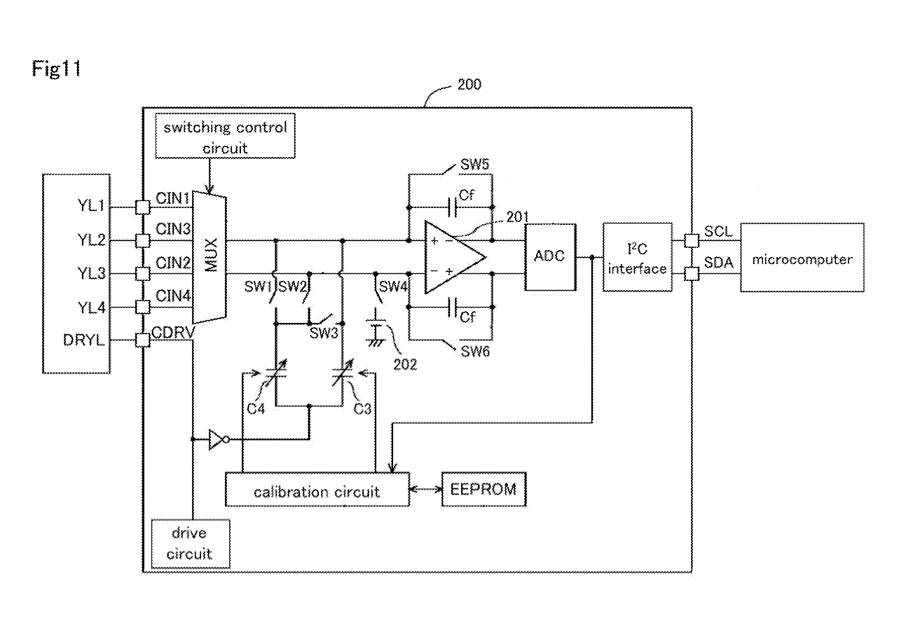

### REFERENCE NUMERAL LIST

1, 1a, 1A, 1Aa touch panel system
2, 2A drive section
3, 3a, 3A, 3Aa amplifier
4, 4A switching means
10, 10A touch sensor panel
20, 20A touch panel controller
90 electronic equipment
91 operation key
92 display section
93 speaker
94 microphone
95 camera
96 CPU (central processing unit)
97 RAM
98 ROM
DL1 to DLm drive line
SL1 to SLn, SLa sense line
C11 to Cnm, C1a to Cna electrostatic capacitance
SW1 to SW4, SW1a to SWna, SW1a′ to SWna′, SW1b to SWmb switch (switching means)
SWA to SWC switch
Vcom predetermined voltage outputting section

### DESCRIPTION OF EMBODIMENTS

Hereinafter, a touch panel controller of the present invention, Embodiments 1 and 2 of a touch panel system using the same, and Embodiment 3 of an electronic equipment such as a mobile phone device with a camera using the touch panel controller and system is explained in detail while referring to the Figures.

### Embodiment 1

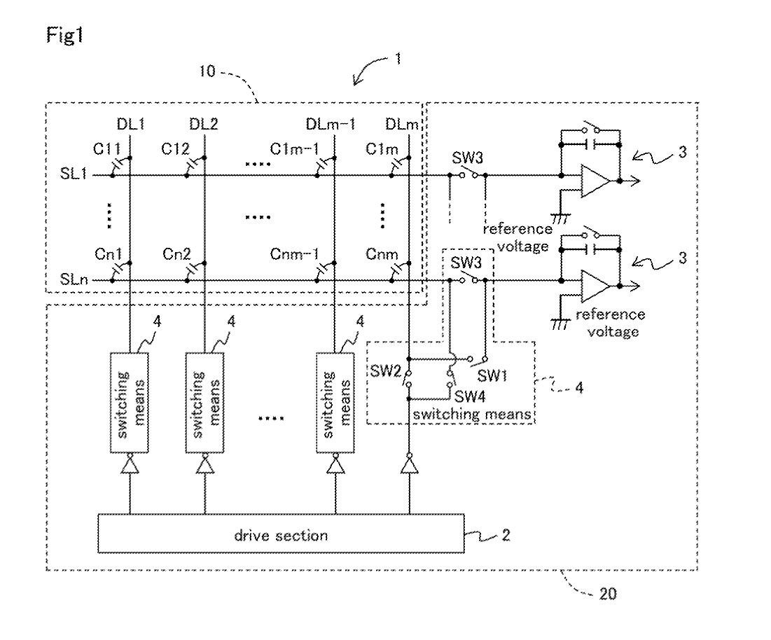

FIG. 1 is a schematic diagram showing an example configuration of an essential part of a touch panel system in Embodiment 1 of the present invention.

In FIG. 1, a touch panel system 1 of Embodiment 1 has a touch sensor panel 10 and a touch panel controller 20 for detecting a position where there is a change in a plurality of electrostatic capacitance C11 to Cnm in a matrix shape occurring between M drive lines DL1 to DLm and N sense lines SL1 to SLn that three-dimensionally intersect therewith of the touch sensor panel 10.

The touch sensor panel 10 has the M drive lines DL1 to DLm arranged in a longitudinal direction, the N sense lines SL1 to SLn arranged in a transverse direction and intersect therewith, and retaining sections of a plurality of electrostatic capacitance C11 to Cnm, in which capacitance occurs in a matrix shape at positions of intersections of the M drive lines DL1 to DLm and N sense lines SL1 to SLn. The touch sensor panel 10 is disposed on a display screen of a display section so that the touch panel controller 20 detects a touched position on the touch sensor panel 10 by a finger or a pen.

The touch panel controller 20 has a drive section 2 for sequentially driving the M drive lines DL1 to DLm of the touch sensor panel 10 at least one at a time, an amplifier 3 for amplifying a capacitance signal from the sense lines SL1 to SLn, and switching means 4 for switching the functionality of the drive lines DL1 to DLm and the sense lines SL1 to SLn thereby switching from the relationship between the drive section 2 and the drive lines DL1 to DLm to the relationship between the drive section 2 and the sense lines SL1 to SLn. The touch panel controller 20 uses an amplified output from the amplifier 3 constituting a preceding stage to detect a position where there is a change in electrostatic capacitance on the touch sensor panel 10.

The drive section 2 sequentially drives the drive lines DL1 to DLm at least one at a time based on series of symbols of n rows and m columns. If an element of a symbol matrix is “1”, the drive section 2 applies a drive voltage. If an element of a symbol matrix is “0”, zero volts are applied. Elements of a symbol matrix are not necessarily limited to two values and may be multi-valued. For example, if an element of a symbol matrix is “−1”, a negative drive voltage is applied. If an element of a symbol matrix is “0.5”, half the drive voltage of “1” is applied. The drive section 2 sequentially drive the drive lines DL1 to DLm at least one at a time based on series of symbols of length P (P≧M) to output a first linear sum output from a plurality of first electrostatic capacitance Ca1 to Cam (a is a natural number; a≧n) from each of the sense lines SLa (a is a sense line SL of any row).

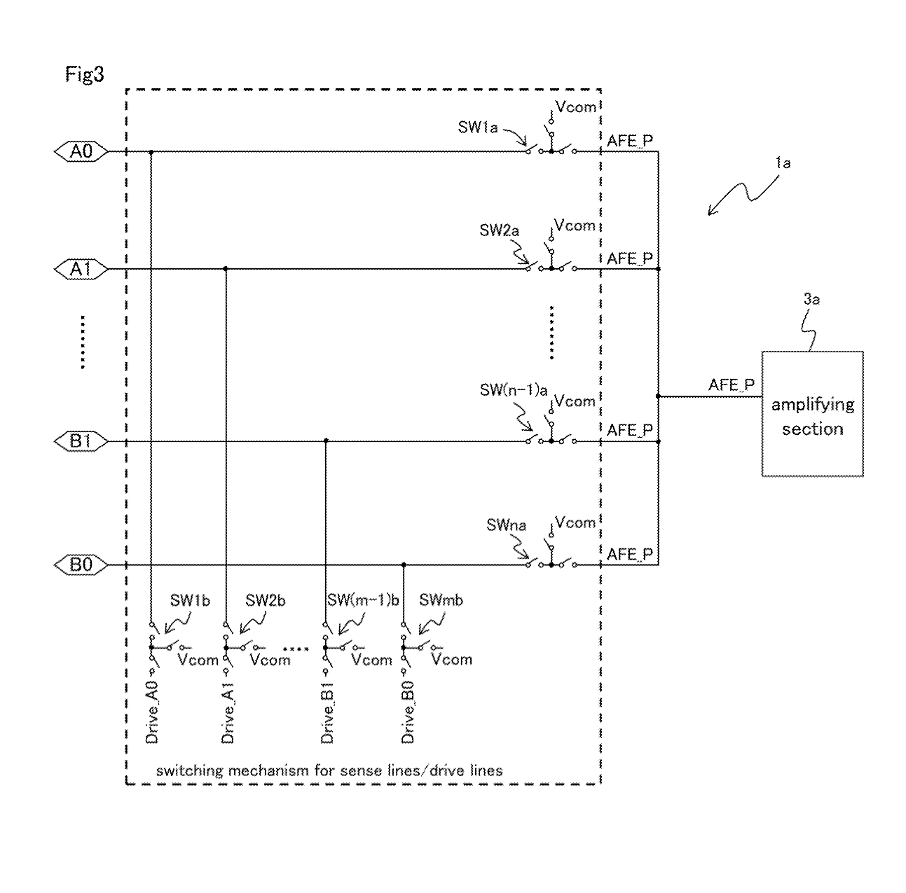

The amplifier 3 amplifies and outputs in a single input a first linear sum output from each of the plurality of first electrostatic capacitance C11 to Cnm formed between the sequentially driven M drive lines DL1 to DLm and each sense line SL among the N sense lines SL1 to SLn intersecting therewith. The amplifier 3 is disposed herein for each of the N sense lines SL1 to SLn. It is also possible to configure the touch panel system such that a single amplifier 3a discussed below is used for the N sense lines SL1 to SLn to amplify and output in a time division. This case is shown in FIG. 3.

The switching means 4 is comprised of switches SW1 to SW4. The drive lines DL1 to DLm and the sense lines SL1 to SLn can be switched by controlling the switches SW1 to SW4 on and off.

For example, a drive voltage supplying end of the drive line DLm is connected to an amplifier input end, which is an end section of the sense line SLn, through the switch SW1. The drive voltage supply end of the drive line DLm is connected to an inverter output end of the drive section 2 through the switch SW2. The end section of the sense line SLn is connected to a connection point between the amplifier input end and the switch SW1 through the switch SW3. Furthermore, a connection point between the switch SW2 and the inverter output end of the drive section 2 is connected to a connection point between the end section of the sense line SLn and the switch SW3 through the switch SW4.

For example, when the switch SW2 and the switch SW3 are on and the switch SW1 and the switch SW4 are off, the drive lines DL and the sense lines SL operate as normal. However, when switching this function, the switch SW2 and the switch SW3 are turned off and the switch SW1 and the switch SW4 are tuned on. At this time, the drive voltage supplying end of the drive line DL is connected to the amplifier input end through the switch SW1 so that the drive line is now the sense line. Further, the inverter output end of the drive section 2 is connected to the end section of the sense line SLn through the switch SW4 to enable driving the sense line SL so that the sense line is now the drive line.

In summary, the switch SW1 is turned off to release the connection between the end section of the drive line DL and the amplifier input end while connecting the end section of the sense line SL to the amplifier input end through the switch SW3. Further, the switch SW4 is turned off to release the connection between the inverter output end of the drive section 2 and the end section of the sense line SL while connecting the inverter output end of the drive section 2 to the drive voltage supplying end of the drive line through the switch SW2.

When the drive line DL is switched to the sense line SL, the switch SW3 is turned off to release the connection between the end section of the sense line SL and the amplifier input end while connecting the drive voltage supplying end of the drive line to the amplifier input end through the switch SW1. Further, when the sense line SL is switched to the drive line DL, the switch SW2 is turned off to release the connection between the inverter output end of the drive section 2 and the drive voltage supplying end of the drive line while connecting the inverter output end of the drive section 2 to the end section of the sense line SL through the switch SW4.

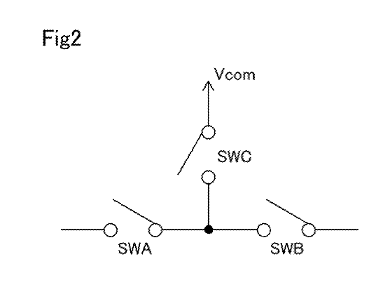

In this regard, FIG. 2 is used to explain the principles of the present invention for reducing an effect of an error factor due to a leakage current via an off resistance of a switching means to an input section of the amplifier 3.

FIG. 2 is a circuit diagram showing a detailed configuration of each of the switches SW1 to SW4 used in the touch panel system of FIG. 1.

In FIG. 2, each of the switches SW1 to SW4 of a line switching mechanism has a T-shape connection configuration, in which one end of a switch SWC is connected to a connection point of two switches SWA and SWB. The two switches SWA and SWB turn on or off a line. When the two switches SWA and SWB are off, a predetermined voltage is applied to the connection point thereof through the switch SWC. The predetermined voltage is the same voltage as the voltage of at an operation point of the amplifier 3 (e.g., Vdd/2).

The switches SW1 to SW4 are provided as the switching means 4 between the input end of the amplifier 3 and the drive line DL and the sense line SL. Each of the switches SW constituting the switching means 4 has at least two switches SWA and SWB connected in series and a predetermined voltage applying predetermined voltage applying means to a node between the two switches SWA and SWB through the switch SWC when the at least two switches SWA and SWB are in an off state. The predetermined voltage applying means is comprised of the switch SWC and a predetermined voltage outputting section Vcom for outputting a predetermined voltage to the node through the switch SWC.

Thereby, if a voltage that is the same as the voltage at an operation point of the amplifier 3 is applied to the connection point (node) of the two switches SWA and SWB through the switch SWC when the two switches are off, the voltage on the amplifier side of the two switches SWA and SWB would be the same voltage as the voltage at the connection point of the two switches SWA and SWB so that a leakage current via an off resistance of the switches would not flow. For this reason, an effect of an error factor due to a leakage current via an off resistance when a switch is disposed on the input side of the amplifier 3 can be eliminated or reduced to enable correct and fast detection of a change in capacitance of electrostatic capacitance more accurately.

The above description explains a case of using the amplifier 3 for each of the plurality of sense lines SL to amplify signals simultaneously. However, the present invention is not limited thereto. A single amplifier 3a discussed below may be used for the plurality of sense lines SL to sequentially amplify in a time division. This case is shown in FIG. 3.

FIG. 3 is a schematic diagram for explaining a case of using one amplifier for a plurality of sense lines SL for sequentially amplifying in a time division in the touch panel system of FIG. 1. FIG. 3 describes the sense lines SL and the drive lines DL in common with respect to a line switching mechanism for sense lines/drive lines.

In FIG. 3, a switch SW1a, switch SW2a . . . switch SW(n-1)a and switch SWna are sequentially turned on from off to sequentially input sense signals from each of the sense lines SL into an input end of an amplifier 3a in a touch panel system 1a. In this case, although a chip region occupied by the amplifier 3a is smaller by using time division operation to configure the touch panel system with a single amplifier 3a, there is a tradeoff relationship in that N switches for switching each of the sense lines SL is required and processing speed is slower instead.

Meanwhile, a line switching mechanism for the plurality of drive lines DL and the plurality of sense lines SL within the dotted line (line switching mechanism for sense lines/drive lines) has switches SW1b to SWmb of a switching mechanism for the drive lines DL and the switches SW1a to SWna of a switching mechanism for the sense lines SL.

Each of the switches SW1a to SWna and the switches SW1b to SWmb uses a switching means connecting one end of the switch SWC to the connection point of the two switches SWA and SWB. Also in this case, a predetermined voltage is applied to the connection of the two switches SWA and SWB through the switch SWC when the two switches SWA and SWB are off to inhibit or prevent a switch-off current. The predetermined voltage is preferably the same voltage as the voltage at an operation point of the amplifier 3a (e.g., Vdd/2). Thereby, a leakage current from another line is inhibited from entering.

FIG. 3 of Embodiment 1 applies a switching means for connecting one end of the switch SWC to the connection point of the two switches SWA and SWB, in which a predetermined voltage is applied to the connection point of the two switches SWA and SWB through the switch SWC when the two switches SWA and SWB are off, to each of the switches SW1b to SWmb constituting a line switching mechanism and the switches SW1a to SWna for switching each sense line SL to a single amplifier 3a. However, the present invention is not limited thereto. In a case where there is no line switching mechanism, it is only necessary to apply a switching means for connecting one end of the switch SWC to the connection point of the two switches SWA and SWB, in which a predetermined voltage (e.g., same voltage as the voltage at an operation point of the amplifier 3a, for example Vdd/2) is applied to the connection point of the two switches SWA and SWB through the switch SWC when the two switches are off, to each of the switches SW1a to SWna for switching each sense line SL to a single amplifier 3a.

According to Embodiment 1 from the above, in the touch panel controller 20 for detecting a touched position on a screen by estimating or detecting a capacitance value after driving the plurality of drive lines DL of the touch sensor panel 10 and amplifying the capacitance value of electrostatic capacitance C occurring in a matrix shape from the plurality of sense lines SL that three-dimensionally intersect with the drive lines with the amplifier 3, the touch panel controller 20 has at least two switching means SWA and SWB connected in series and a predetermined voltage applying section Vcom for outputting a predetermined voltage to the node between the two switching means SWA and SWB through the switching means SWC when the two switching means SWA and SWB are in an off state between the input end of the amplifier 3 and the sense line SL. The touch panel controller has the drive section 2 for sequentially driving the plurality of drive lines DL at least one at a time to allow a first linear sum output to be output from a plurality of first electrostatic capacitance formed between the plurality of drive lines DL and each sense line SL. The amplifier 3 amplifies the first linear sum output in a single input.

Thereby, the touch panel controller has at least two switching means SWA and SWB connected in series and a predetermined voltage applying means (herein, switch SWC and voltage source Vcom) for applying a predetermined voltage to a node between the two switching means SWA and SWB when the two switching means SWA and SWB are in an off state between the input end of the amplifier 3 or 3a and each of the sense lines SL. Thus, an effect of an error factor due to a leakage current via an off resistance when switching means (switches SW1 and SW3) are disposed on the input side of the amplifier 3 or 3a is reduced to enable correct detection of a change in capacitance of electrostatic capacitance more accurately. In summary, an effect of an amplification error due to a leakage current via an off resistance is diminished.

Further, it is possible to inhibit a leakage current from another line from entering, share sense lines and drive lines, and enhance versatility of chips.

### Embodiment 2

The above-described Embodiment 1 explains a case in which the amplifier 3 or 3a of the touch panel controller 20 has a single input. However, Embodiment 2 explains a case in which an amplifier 3A or 3Aa of a touch panel controller 20A discussed below is a two input differential amplifier.

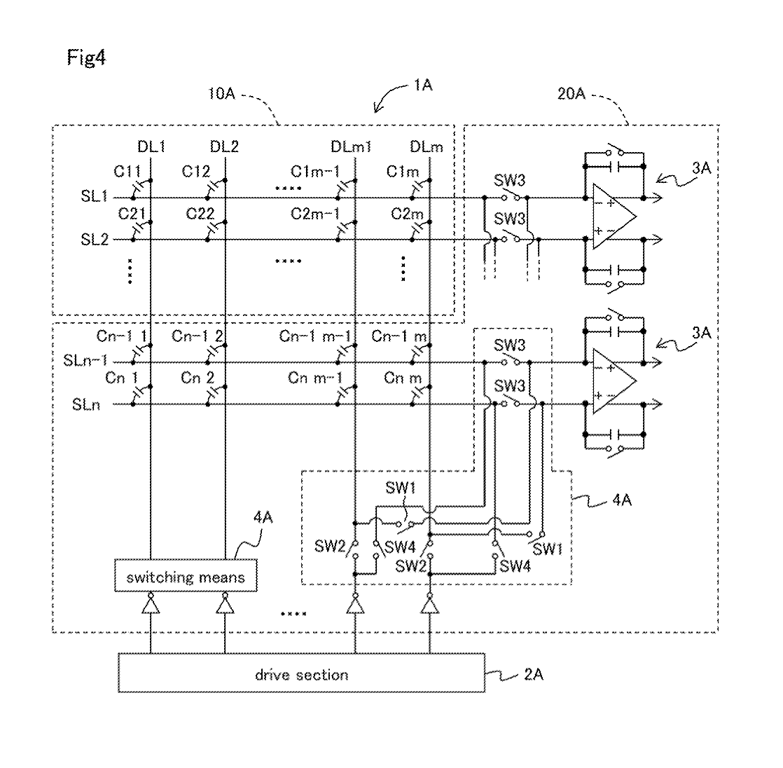

FIG. 4 is a schematic diagram showing an example configuration of an essential part of a touch panel system in Embodiment 2 of the present invention.

In FIG. 4, a touch panel system 1A of Embodiment 2 comprises a touch sensor panel 10A and a touch panel controller 20A for detecting a position where there is a change in a plurality of electrostatic capacitance C11 to Cnm in a matrix occurring between M drive lines DL1 to DLm and N sense lines SL1 to SLn that three-dimensionally intersect therewith of the touch sensor panel 10.

The touch sensor panel 10A has the M drive lines DL1 to DLm arranged in a longitudinal direction, the N sense lines SL1 to SLn arranged in a transverse direction and three-dimensionally intersecting therewith, and retaining sections of a plurality of electrostatic capacitance C11 to Cnm, in which capacitance occurs in a matrix shape at positions of intersections of the M drive lines DL1 to DLm and N sense lines SL1 to SLn. The touch sensor panel 10A is disposed on a display screen of a display section so that the touch panel controller 20A detects a touched position on the touch sensor panel 10A by a finger or a pen.

The touch panel controller 20A has a drive section 2A for sequentially driving the M drive lines DL1 to DLm of the touch sensor panel 10A at least one at a time, an amplifier 3A for differentially amplifying two capacitance signals from the sense lines SL1 to SLn, and a switching means 4A for switching the functionality of the drive lines DL1 to DLm and sense lines SL1 to SLn thereby switching from the relationship between the drive section 2A and the drive lines DL1 to DLm to the relationship between the drive section 2A and sense lines SL1 to SLn.

A drive section 2A sequentially drives the drive lines DL1 to DLm at least one at a time based on series of symbols of n rows and m columns. If an element of a symbol matrix is “1”, the drive section 2 applies a drive voltage. If an element of a symbol matrix is “0”, zero volts are applied. Elements of a symbol matrix are not necessarily limited to two values and may be multi-valued. For example, if an element of a symbol matrix is “−1”, a negative drive voltage is applied. If an element of a symbol matrix is “0.5”, half the drive voltage of “1” is applied. The drive section 2 sequentially drive the drive lines DL1 to DLm at least one at a time based on series of symbols of length P (P≧M) to output a first linear sum output from a plurality of first electrostatic capacitance Cal to Cam (a is a natural number; a≧n) from two of the sense lines SLa.

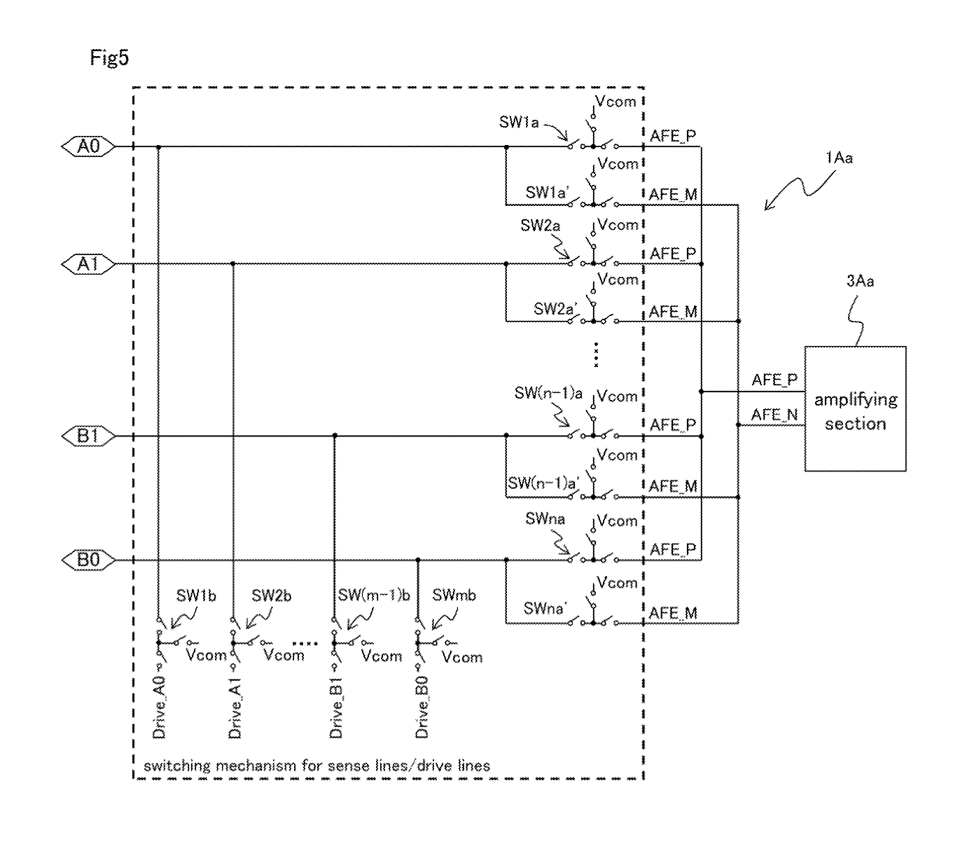

The amplifier 3A amplifies and outputs a differential component between a first linear sum output from each of the plurality of first electrostatic capacitance C11 to Cnm formed between the sequentially driven M drive lines DL1 to DLm and one of the N sense lines SL1 to SLn intersecting therewith, e.g., sense line SL1, and a second linear sum output from each of a plurality of second electrostatic capacitance C21 to C2m formed between the M drive lines DL1 to DLm and another sense line SL2 adjacent to the sense line SL1. The amplifier 3A is disposed for each two N sense lines SL1 to SLn. It is also possible to configure the touch panel system such that a single amplifier 3A is used for N sense lines SL1 to SLn to differentially amplify and output in a time division. This case is shown in FIG. 5.

The switching means 4A is comprised of switches SW1 to SW4. The drive lines DL1 to DLm and the sense lines SL1 to SLn can be switched by controlling the switches SW1 to SW4 on and off.

For example, a drive voltage supplying end of the drive line DLm-1 is connected to an amplifier input end, which is an end section of the sense line SLn-1, through the switch SW1. The drive voltage supplying end of the drive line DLm-1 is connected to an inverter output end of the drive section 2A through the switch SW2. The end section of the sense line SLn-1 is connected to a connection point between a first amplifier input end and the switch SW1 through the switch SW3. Furthermore, a connection point between the switch SW2 and the inverter output end of the drive section 2A is connected to a connection point between the end section of the sense line SLn-1 and the switch SW3 through the switch SW4.

Similarly, a drive voltage supplying end of the drive line DLm is connected to an amplifier input end, which is an end section of the sense line SLn, through the switch SW1. The drive voltage supplying end of the drive line DLm is connected to the inverter output end of the drive section 2A through the switch SW2. The end section of the sense line SLn is connected to a connection point between the amplifier input end and the switch SW1 through the switch SW3. Furthermore, the connection point between the switch SW2 and the inverter output end of the drive section 2A is connected to the connection point between the end section of the sense line SLn and the switch SW3 through the switch SW4.

For example, when the switch SW2 and the switch SW3 are on and the switch SW1 and the switch SW4 are off, the drive lines DL and the sense lines SL operate as normal. However, when switching the functionality of the drive lines to the sense lines, the switch SW2 and the switch SW3 are turned off and the switch SW1 and the switch SW4 are tuned on. At this time, the drive voltage supplying end of the drive line DL is connected to the amplifier input end through the switch SW1 so that the drive line is now the sense line. Further, the inverter output end of the drive section 2 is connected to the end section of the sense line SLn through the switch SW4 and can drive the sense line SL so that the sense line is now the drive line.

In sum, the switch SW1 is turned off to release the connection between the end section of the drive line DL and the amplifier input end while connecting the end section of the sense line SL to the amplifier input end through the switch SW3. Further, the switch SW4 is turned off to release the connection between the inverter output end of the drive section 2A and the end section of the sense line SL while connecting the inverter output end of the drive section 2A to the drive voltage supplying end of the drive line DL through the switch SW2.

When the drive line DL is to be the sense line SL, the switch SW3 is turned off to release the connection between the end section of the sense line SL and the amplifier input end while connecting the drive voltage supplying end of the drive line DL to the amplifier input end through the switch SW1. Further, when the sense line SL is to be the drive line DL, the switch SW2 is turned off to release the connection between the inverter output end of the drive section 2 and the drive voltage supplying end of the drive line DL while connecting the inverter output end of the drive section 2 to the end section of the sense line SL through the switch SW4.

As shown in FIG. 2, each of the switches SW1 to SW4 has a T-connection configuration in which one end of a switch SWC is connected to a connection point of two switches SWA and SWB. When the two switches SWA and SWB are off, a predetermined voltage is applied through the switch SWC at the connection point thereof. The predetermined voltage is the same voltage as the voltage at an operation point of the amplifier 3A (e.g., Vdd/2).

Thereby, if a voltage that is the same as the voltage at an operation point of the amplifier 3A is applied to the connection point (node) of the two switches SWA and SWB through the switch SWC when the two switches are off, the voltage on the amplifier side of the two switches SWA and SWB would be the same voltage as the voltage at the connection point of the two switches SWA and SWB so that a leakage current via an off resistance of the switches would not flow. For this reason, an effect of an error factor due to a leakage current via an off resistance when a switch is disposed on the input side of the amplifier 3A can be reduced to enable correct detection of a change in capacitance of electrostatic capacitance more accurately.

The above description explains a case of using multiple amplifiers 3A with two inputs for each two of the plurality of sense lines SL to differentially amplify signals simultaneously. However, the present invention is not limited thereto. A single amplifier 3Aa discussed below with two inputs may be used for the plurality of sense lines SL to sequentially amplify in a time division. This case is shown in FIG. 5.

FIG. 5 is a schematic diagram for explaining a case of sequentially amplifying in a time division using a two-input differential amplifier for the plurality of sense lines SL in the touch panel system 1A of FIG. 4. FIG. 5 describes the sense lines SL and drive lines DL in common with respect to a line switching mechanism for sense lines/drive lines.

In FIG. 5, in a touch panel system 1Aa, a switch SW1a, switch SW2a . . . switch SW(n-2)a, and switch SW(n-1)a are sequentially turned on from off to sequentially input sense signals from each of the sense lines SL into one of two input ends of a single amplifier 3Aa. In addition, a switch SW2a′, switch SW3a′ . . . switch SW(n-1)a′, and switch SWna′ are sequentially turned on from off to sequentially input sense signals from each of the sense lines SL into the other of the two input ends of the single amplifier 3Aa. In summary, signals from the switch SW1a and the switch SW2a′, the switch SW2a and the switch SW3a′ . . . the switch SW(n-2)a and the switch SW(n-1)a′ , and the switch SW(n-1)a and the switch SWna′ are sequentially input into the two input ends of a single amplifier 3Aa. In this case, although a chip region occupied by the amplifier 3Aa is smaller by using a time division operation to configure the touch panel system with a single amplifier 3Aa, there is a tradeoff relationship in that N switches SW for switching each of the sense lines SL is required and processing speed is slower instead.

Meanwhile, a line switching mechanism for the plurality of drive lines DL and the plurality of sense lines SL within the dotted line (line switching mechanism for sense lines/drive lines) has switches SW1b to SWmb of a switching mechanism for the drive lines DL and the switches SW1a to SWna and the switches SW1a′ to SWna′ of a switching mechanism for the sense lines SL.

Each of the switches SW1a to SWna, the switches SW1a′ to SWna′, and the switches SW1b to SWmb is configured as a switching means connecting one end of the switch SWC to the connection point of the two switches SWA and SWB. In this case, a predetermined voltage is applied to the connection point of the two switches SWA and SWB through the switch SWC when the two switches are off. The predetermined voltage is the same voltage as the voltage at an operation point of the amplifier 3Aa (e.g., Vdd/2). Thereby, a leakage current from another line is inhibited from entering.

FIG. 5 of Embodiment 2 applies a switching means for connecting one end of the switch SWC to the connection point of the two switches SWA and SWB, in which a predetermined voltage is applied to the connection point of the two switches SWA and SWB through the switch SWC when the two switches are off, to each of the switches SW1b to SWmb constituting a line switching mechanism (line switching mechanism for sense lines/drive lines) and the switches SW1a to SWna and the switches SW1a′ to SWna′ for switching each sense line SL to a single amplifier 3Aa. However, the present invention is not limited thereto. In a case where there is no line switching mechanism, it is only necessary to apply a switching means for connecting one end of the switch SWC to the connection point of the two switches SWA and SWB, in which a predetermined voltage (e.g., same voltage as the voltage at an operation point of the amplifier 3Aa, for example Vdd/2) is applied to the connection point of the two switches SWA and SWB through the switch SWC when the two switches are off, to each of the switches SW1a to SWna and the switches SW1a′ to SWna′ for switching each sense line SL to a single amplifier 3Aa.

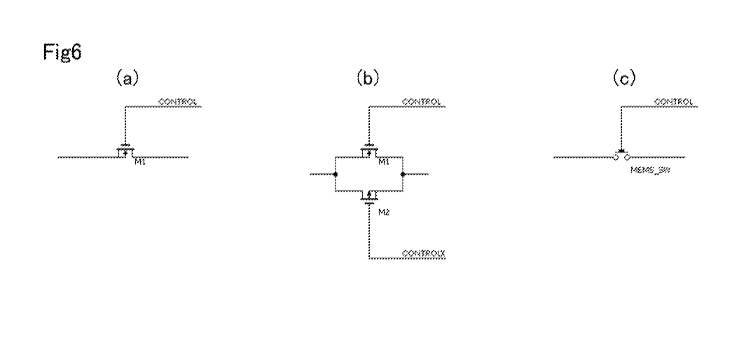

Although an explanation was not particularly provided in the above-described Embodiments 1 and 2, the switches SWA, SWB, and SWC are one of MOS transistor switching means of FIG. 6(a), CMOS switching means of FIG. 6(b) and MEMS switching means of FIG. 6(c), or a combination thereof. In particular, since an on resistance is greater at high or low voltage for a switch comprised of only NMOS or PMOS in a CMOS switching means, a CMOS switching means is desirable in order to achieve excellent on-resistance in a wide range of voltages. Further, use of an MEMS switching means decreases an on resistance of a switch and increases an off resistance of the switch to enable a more ideal switching operation.

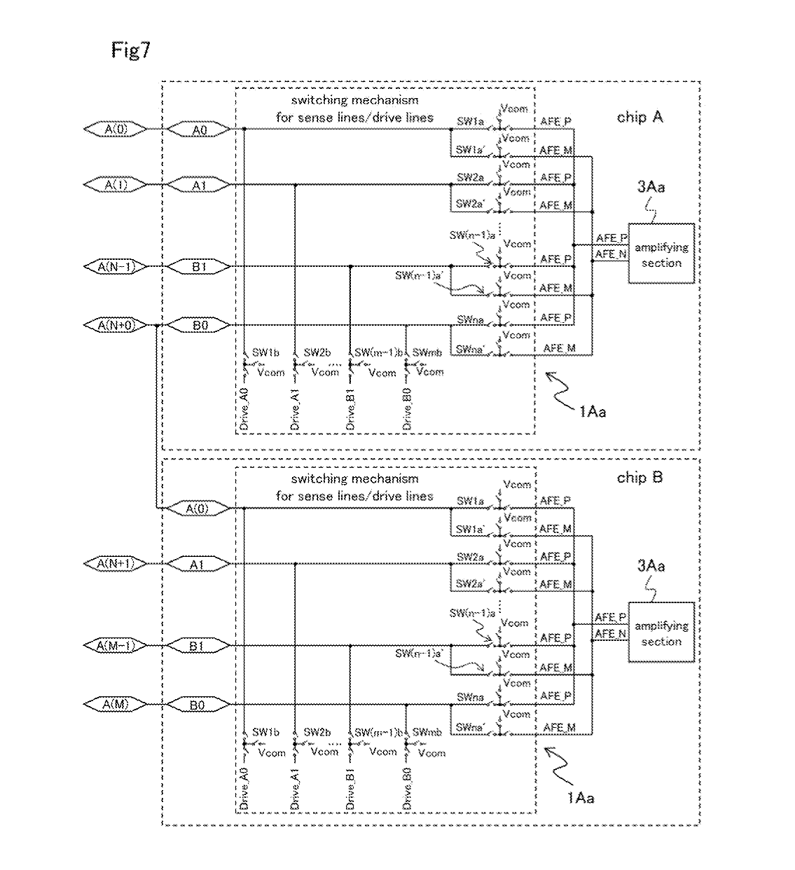

FIG. 7 is a schematic diagram showing a case of connecting the touch panel system 1Aa of FIG. 5 as chip A and chip B.

FIG. 7 considers a timing of detecting A(N+0)−A(N−1) in chip A and detecting A(N+2)−A(N+1) in chip B as an example of one operational timing.

A(N+0) processed in chip A is also input into chip B. A (N+2) and A(N+1) processed in chip B are affected via off resistances (switches SW1a and SW1a′), which are connected to a common voltage Vcom via an off resistance in the present invention. As state above, if the common voltage Vcom is the same voltage as that of the operation point of the amplifier 3Aa, a leakage current would not flow through an off resistance. Thus, a line capacitance signal at (N+0) in chip A is inhibited or prevented from being input into chip B via off resistances (switches SW1a and SW1a′). Hence, the line of A(N+0) processed in chip A would not affect A(N+2) or A(N+1). Thereby, a leakage current from another line is inhibited from entering.

According to Embodiment 2 from the above, in the touch panel controller 20A for detecting a touched position on a screen by estimating or detecting a capacitance value after driving the plurality of drive lines DL of the touch sensor panel 10A and amplifying the capacitance value of electrostatic capacitance C occurring in a matrix shape from the plurality of sense lines SL that three-dimensionally intersect with the drive lines with the amplifier 3A, the touch panel controller 20A has at least two switching means SWA and SWB connected in series and a predetermined voltage applying section Vcom for outputting a predetermined voltage to a node between the two switching means SWA and SWB through the switching means SWC when the two switching means SWA and SWB are in an off state between the two input ends of the amplifier 3A and each sense lines SL. The touch panel controller has the drive section 2A for sequentially driving the plurality of drive lines DL at least one at a time to allow a first linear sum output to be output from a plurality of first electrostatic capacitance formed between the plurality of drive lines DL and one of the plurality of sense lines SL intersecting therewith from one of the sense lines SL and to allow a second linear sum output to be output from the plurality of second electrostatic capacitance formed between the plurality of drive lines DL and another sense line SL adjacent to the one of the sense lines SL. The amplifier 3A is a differential amplifier that differentially amplifies the difference between the first linear sum output and the second linear sum output.

Thereby, the touch panel controller has at least two switches SWA and SWB connected in series between the two input ends of the amplifier 3A or 3Aa and each sense lines SL and a predetermined voltage applying means (herein, switch SWC and voltage source Vcom) for applying a predetermined voltage to the node between the two switches SWA and SWB when the two switches SWA and SWB are in an off state. Thus, an effect of an error factor due to a leakage current via an off resistance when switching means (switches SW1 and SW3) are disposed on the input side of the amplifier 3A or 3Aa is reduced to enable correct detection of a change in capacitance of electrostatic capacitance more accurately.

Even when utilizing a differential signal, it is possible to inhibit a leakage current from another line from entering. In this manner, it is possible to inhibit a leakage current from another line, share sense lines and drive lines, and enhance versatility of chips.

Furthermore, the configuration of connecting the lines to both differential input ends of the amplifier 3A or 3Aa is configured symmetrically so that even if there is a leakage current, it would be less likely to appear in an output because the current would enter differential inputs in a similar manner.

Although an explanation was not particularly provided in the above-described Embodiments 1 and 2, when M drive lines DL and N sense lines SL are switched where M is different from N and M is greater than N, it is necessary to prepare in advance amplifiers 3 or 3A or wirings of the input ends of the amplifier 3a or 3Aa in the amount of M lines, or to prepare in advance output ends from the drive section 2 or 2A in the amount of N lines when N is greater than M.

### Embodiment 3

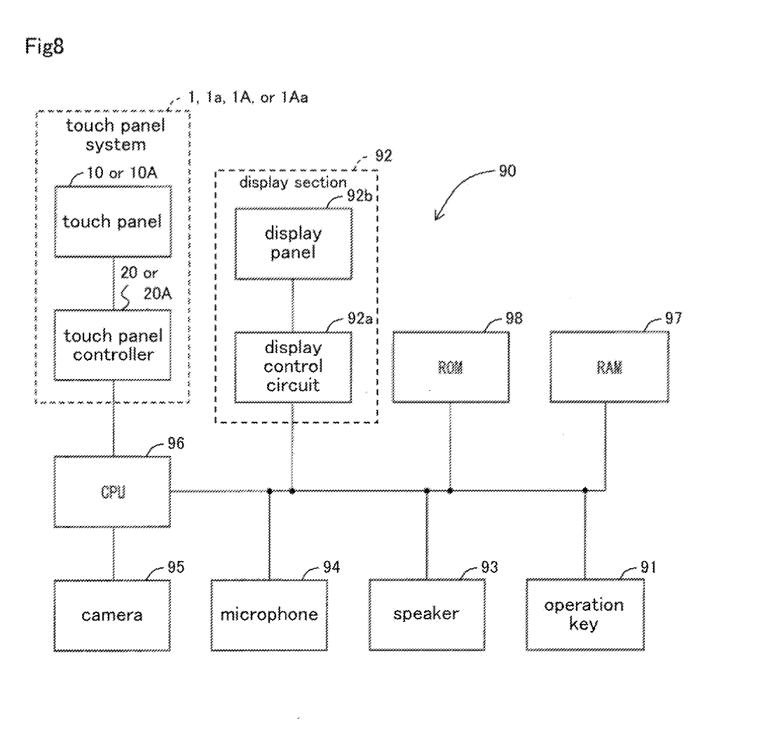

FIG. 8 is a block diagram showing an example of a schematic configuration of an electronic equipment such as a mobile phone device using the touch panel system 1, 1a, 1A, or 1Aa of Embodiment 1 or 2 of the present invention as Embodiment 3 of the present invention.

In FIG. 8, an electronic equipment 90 of Embodiment 3 is constituted with a computer system and comprises: the touch panel system 1, 1a, 1A or 1Aa of Embodiments 1 or 2 described above, an operation key 91 allowing various input commands such as a keyboard or a mouse, a display section 92 enabling the display of various images, such as an initial screen, selection screen and processing screen, on a display screen in accordance with the various input commands, a speaker 93, a microphone 94, a camera 95, a CPU 96 (central processing unit) as a controlling section for performing overall control, RAM 97 as a temporary storing means functioning as a working memory at startup of the CPU 96 and ROM 98, as a computer readable recording medium (storing means) recorded with control program for operating the CPU 96, a variety of data used therefor, and the like.

The ROM 98 is comprised of a readable recording medium (storing means) such as a hard disk, optical disk, magnetic disk or IC memory. The control program and the variety of data used therefor may be downloaded to the ROM 98 from a portable optical disk, magnetic disk, IC memory or the like, or a hard disk of a computer, or downloaded to the ROM 98 from a hard disk, or downloaded to the ROM 98 through wireless or wired connection, internet or the like.

For example, mobile phones device such as a mobile phone device with a camera, mobile terminal devices and information processing devices are contemplated as the electronic equipment 90. Mobile terminal devices include smartphones, tablets and the like. Information processing devices include PC monitors, signage, electronic black boards, information displays and the like.

As described above, the present invention is exemplified by the use of its preferred Embodiments 1 to 3 of the present invention. However, the present invention should not be interpreted solely based on Embodiments 1 to 3. It is understood that the scope of the present invention should be interpreted solely based on the scope of the claims . It is also understood that those skilled in the art, can implement equivalent scope of technology, based on the description of the present invention and common knowledge from the description of the detailed preferred Embodiments 1 to 3 of the present invention. Furthermore, it is understood that any patent, any patent application and any references cited in the present specification should be incorporated by reference in the present specification in the same manner as the contents are specifically described therein.

### INDUSTRIAL APPLICABILITY

The present invention can be applied in the field of a touch panel controller for detecting a touch position on a screen by driving a drive line of a touch sensor panel and estimating or detecting a capacitance value of electrostatic capacitance between sense lines and drive lines, a touch panel system using the touch sensor panel and the touch panel controller, and an electronic equipment using the touch panel system. According to the present invention, an effect of an error factor due to a leakage current via an off resistance when a switch is disposed on the input side of an amplifier can be reduced to enable correct detection of a change in capacitance of electrostatic capacitance more accurately.

1. A touch panel controller for detecting a touched position on a screen by estimating or detecting a capacitance value after driving a plurality of drive lines of a touch sensor panel and amplifying the capacitance value of electrostatic capacitance between sense lines and the drive lines with an amplifier, comprising, between an input end of the amplifier and sense line,
at least two switching means connected in series, and
a predetermined voltage applying means for applying a predetermined voltage to a node between the two switching means when the two switching means are in an off state.

2. The touch panel controller of claim 1, wherein the predetermined voltage applying means comprises a switching means whose one end is connected to the node, and a predetermined voltage outputting section connected to the other end of the switching means.

3. The touch panel controller of claim 2, wherein the predetermined voltage is a voltage that is the same voltage as a voltage at an operation point of the amplifier or Vdd/2.

4. The touch panel controller of claim 1, wherein the at least two switching means connected in series are CMOS switching means or MEMS switching means.

5. The touch panel controller of claim 1, wherein the touch panel controller has a drive section for sequentially driving the plurality of drive lines at least one at a time to allow a first linear sum output to be output from a plurality of first electrostatic capacitance formed between the plurality of drive lines and each one of the sense lines from the each one of the sense lines, and the amplifier amplifies the first linear sum output in a single input.

6. The touch panel controller of claim 1, wherein the touch panel controller has a drive section for sequentially driving the plurality of drive lines at least one at a time to allow a first linear sum output to be output from a plurality of first electrostatic capacitance formed between the plurality of drive lines and one sense line of the plurality of sense lines from the one sense line and to allow a second linear sum output to be output from a plurality of second electrostatic capacitance formed between the plurality of drive lines and another sense line adjacent to the one sense line from the another sense line, and the amplifier is a differential amplifier that differentially amplifies a difference between the first linear sum output and the second linear sum output.

7. The touch panel controller of claim 1, wherein a plurality of switching means for switching the drive lines and the sense lines with each other are provided between the amplifier and the drive lines and the corresponding sense lines, and each of the plurality of switching means comprises the at least two switching means connected in series and a predetermined voltage applying means for applying a predetermined voltage to a node between the two switching means when the two switching means are in an off state.

8. The touch panel controller of claim 1, wherein each of the capacitance values of electrostatic capacitance in the plurality of sense lines is amplified in a time division by using one amplifier.

9. The touch panel controller of claim 8, wherein the touch panel control comprises the at least two switching means connected in series and the predetermined voltage applying means for applying a predetermined voltage to a node between the two switching means when the two switching means are in an off state at each position between one input end of the one amplifier and the plurality of sense lines.

10. The touch panel controller of claim 8, wherein the touch panel controller comprises:
the at least two switching means connected in series and the predetermined voltage applying means for applying a predetermined voltage to a node between the two switching means when the two switching means are in an off state at each position between one of the input ends of the one amplifier and the plurality of sense lines, and
the at least two switching means connected in series and the predetermined voltage applying means for applying a predetermined voltage to a node between the two switching means when the two switching means are in an off state at each position between the other input end of the one amplifier and the plurality of sense lines.

11. The touch panel controller of claim 6, wherein a configuration of connecting to each of both differential input ends of the differential amplifier is a symmetrical circuit configuration.

12. A touch panel system comprising the touch panel controller of claim 1 and the touch sensor panel used by the touch panel controller.

13. An electronic equipment using the touch panel system of claim 12 on a display screen as a position inputting device.
